(19) United States
(12) Patent Application Publication
(10) Pub. No.: US 2010/0246072 A1
(43) Pub. Date: Sep. 30, 2010

(54) HARD DISK DRIVE

(75) Inventor: Shi-Jung Kim, Seoul (KR)

Correspondence Address: STANZIONE & KIM, LLP, 919 18TH STREET, N.W., SUITE 440, WASHINGTON, DC, 20006, US

(73) Assignee: Samsung Electronics Co., Ltd, Suwon-si (KR)

(21) Appl. No.: 12/750,988

(22) Filed: Mar. 31, 2010

(30) Foreign Application Priority Data
Mar. 31, 2009 (KR) 10-2009-0027214

(51) Int. Cl. G11B 5/56

(52) U.S. Cl. 360/294.6; G9B/5.201

(57) ABSTRACT

A hard disk drive having an actuator coupled to a pivot part about which the actuator rotates, including first and second pivot bearings coupled to the actuator and the pivot part, wherein a rotation center of at least one of the first and second pivot bearings is offset from respective longitudinal centers of the first and second pivot bearings.

### CROSS-REFERENCE TO RELATED APPLICATIONS

This application claims the benefit under 35 U.S.C. §119(a) of Korean Patent Application No. 10-2009-0027214, filed on Mar. 31, 2009, in the Korean Intellectual Property Office, the disclosure of which is incorporated herein by reference in its entirety.

### BACKGROUND

1. Field of the Invention

The present general inventive concept relates to an auxiliary memory unit of a computer system, and more particularly, a hard disk drive which can adjust a pivot bearing span and a pivot bearing z-location by a simple and uncomplicated method without changing a structure of a bearing spacer or other neighboring parts.

2. Description of the Related Art

A hard disk drive that has been widely used as an auxiliary memory unit of a computer system or the like includes a base to which a head stack assembly (HSA) having an actuator with a magnetic head is coupled.

The actuator rotates toward a disk with respect to a pivot shaft and allows the magnetic head to record data or load the data on the disk.

In the case in which the actuator is coupled to the pivot shaft of the base, a pair of pivot bearings are first coupled to the pivot shaft with a bearing spacer therebetween, and then the actuator is coupled to the outside of the pivot bearing.

When coupling the actuator with the pivot shaft, a pivot bearing span, i.e., a distance between the respective centers of the pivot bearings is adjusted, and a pivot bearing z-location is adjusted to align a central axis line between the pivot bearings with the center of gravity the actuator has. Of course, both the adjusting work regarding the pivot bearing span and the adjusting work regarding the pivot bearing z-location are generally performed, but at least the pivot bearing span has to be adjusted to prevent the actuator from vibrating forward and backward or leftward and rightward with respect to the pivot shaft when the hard disk drive is driven, thereby securing operational reliability of the hard disk drive.

However, it is difficult for such a conventional hard disk drive to adjust the pivot bearing span or the pivot bearing z-location since the bearing spacer or other neighboring parts should be changed before performing the adjusting work. If the pivot bearing span or the pivot bearing z-location is adjusted under the condition that the structure of the bearing spacer or other neighboring parts is changed by force, the HSA coupled to the pivot shaft may interfere with the cover or the base, and therefore another problem of newly processing the cover or the base is likely to arise.

### SUMMARY

Example embodiments of the present general inventive concept provide a hard disk drive which can adjust a pivot bearing span and a pivot bearing z-location by a simple and uncomplicated method without changing a structure of a bearing spacer or other neighboring parts.

Additional features and utilities of the present general inventive concept will be set forth in part in the description which follows and, in part, will be obvious from the description, or may be learned by practice of the general inventive concept.

The foregoing and/or other features and utilities of the present general inventive concept may be achieved by providing a hard disk drive including an actuator provided with a magnetic head; a pivot shaft to which the actuator is coupled and which forms a rotation axis of the actuator, and first and second pivot bearings each internally including rotation balls forming a rotation center and coupled to the pivot shaft to assist rotation of the actuator, wherein at least one of the first and second pivot bearings is configured as an asymmetric pivot bearing having the rotation balls provided at a preset distance from a central axis line in a thickness direction of the asymmetric pivot bearing.

Both of first and second pivot bearings may have the asymmetric pivot bearing configuration.

The rotation bolls provided in the first and second pivot bearings may be arranged more distantly from each other than a distance between the central axis lines in the thickness direction of the first and second pivot bearings.

The rotation bolls provided in the first and second pivot bearings may be arranged closer to each other than a distance between the central axis lines in the thickness direction of the first and second pivot bearings.

The rotation bolls provided in the first and second pivot bearings may be distant in the same direction with respect to the central axis lines in the thickness direction of the first and second pivot bearings.

The first pivot bearing may have the asymmetric pivot bearing configuration, and the second pivot bearing may have a symmetric pivot bearing configuration having the rotation balls provided substantially symmetrically with respect to a thickness direction.

Each of the first and second pivot bearings may include an external wheel internally formed with a hemispherical external wheel groove to partially accommodate the respective rotation balls and externally coupled to the actuator; and an internal wheel externally formed with a hemispherical internal wheel groove to partially accommodate the respective rotation balls and internally coupled to the pivot shaft.

Both the first and second symmetric pivot bearings may form a ball bearing.

The hard disk drive may further include a bearing spacer provided between the first and second pivot bearings.

A pivot bearing span between the respective rotations centers of the first and second pivot bearings and a pivot bearing z-location to align a central axis line between the first and second pivot bearings with the center of gravity of the actuator may be adjusted by selective combination of the first and second pivot bearings.

The foregoing and/or other features and utilities of the present general inventive concept may also be achieved by providing a hard disk drive having an actuator coupled to a pivot part about which the actuator rotates, including first and second pivot bearings coupled to the actuator and the pivot part, wherein a rotation center of at least the first pivot bearing is offset from a longitudinal center of the first pivot bearing.

The hard disk drive may further include a bearing spacer provided between the first and second pivot bearings.

The rotation center of the first pivot bearing may be closer to the second pivot bearing than is the longitudinal center of the first pivot bearing.

The rotation center of the first pivot bearing may be farther from the second pivot bearing than is the longitudinal center of the first pivot bearing.

The first and second pivot bearings may each be provided with a plurality of rotation balls to form respective rotation centers of the first and second pivot bearings.

A rotation center of the second pivot bearing may be offset from a longitudinal center of the second pivot bearing.

A distance between the rotation centers of the first and second pivot bearings may be shorter than the distance between the longitudinal centers of the first and second pivot bearings.

A distance between the rotation centers of the first and second pivot bearings may be longer than a distance between the longitudinal centers of the first and second pivot bearings.

A distance between the rotation centers of the first and second pivot bearings may be substantially equal to a distance between the longitudinal centers of the first and second pivot bearings.

The respective rotation centers of the first and second pivot bearings may be offset at equal distances from the respective longitudinal centers of the first and second pivot bearings.

A distance between the rotation center of the first pivot bearing and the longitudinal center of the first pivot bearing may be shorter than a distance between the rotation center of the second pivot bearing and the longitudinal center of the second pivot bearing.

### BRIEF DESCRIPTION OF THE DRAWINGS

These and/or other features and advantages of the present general inventive concept will become apparent and more readily appreciated from the following description of the embodiments, taken in conjunction with the accompanying drawings of which:

FIG. 1 is an exploded perspective view illustrating a hard disk drive according to an exemplary embodiment of the present general inventive concept;

FIG. 2 is a partial perspective view illustrating the head stack assembly (HSA) and voice coil motor (VCM) of the hard disk drive of FIG. 1;

FIG. 3 is a partial exploded perspective view illustrating the HSA and pivot shaft of FIG. 1;

FIG. 4 is a partial cut-open perspective view illustrating a symmetric pivot bearing;

FIG. 5 is a partial cut-open perspective view illustrating an asymmetric pivot bearing.

FIG. 6 is a partial cross-section view illustrating the hard disk drive of FIG. 1 provided with the symmetric pivot bearing of FIG. 4 and the asymmetric pivot bearing of FIG. 5; and

FIGS. 7 to 11 are partial cross-section views illustrating hard disk drives according to second to fifth exemplary embodiments of the present general inventive concept.

### DETAILED DESCRIPTION OF THE EMBODIMENTS

Reference will now be made in detail to various exemplary embodiments of the present general inventive concept, examples of which are illustrated in the accompanying drawings, wherein like reference numerals refer to like elements throughout. The embodiments are described below in order to explain the present general inventive concept by referring to the figures.

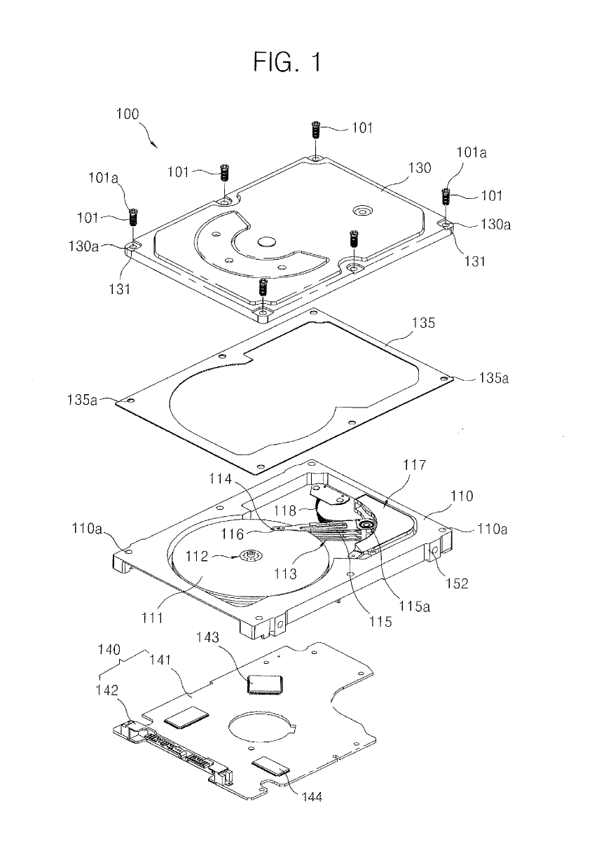

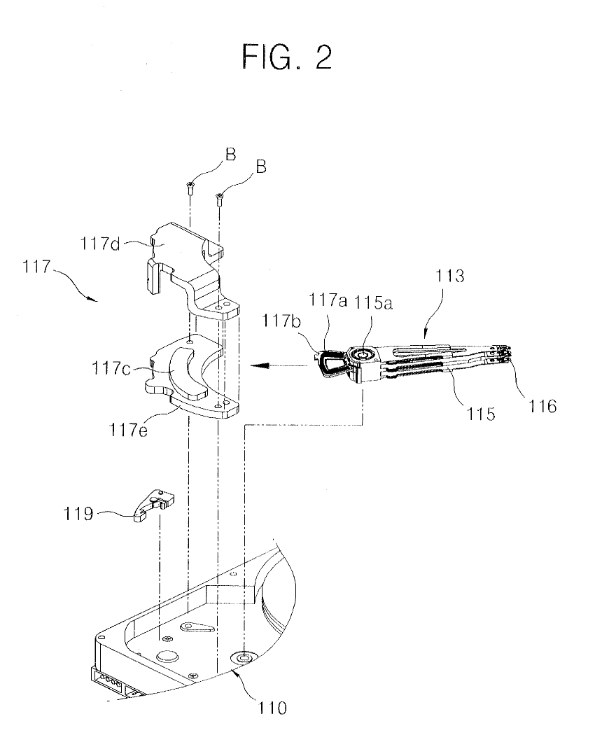

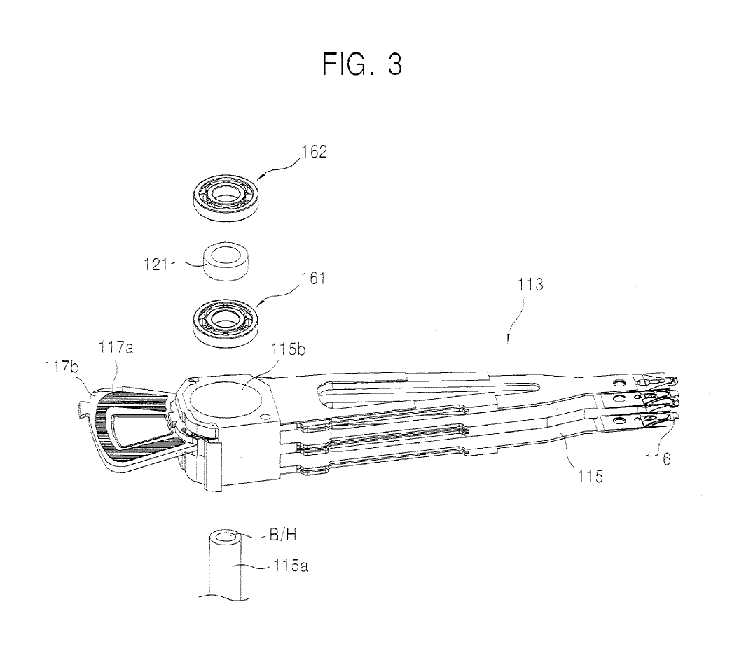

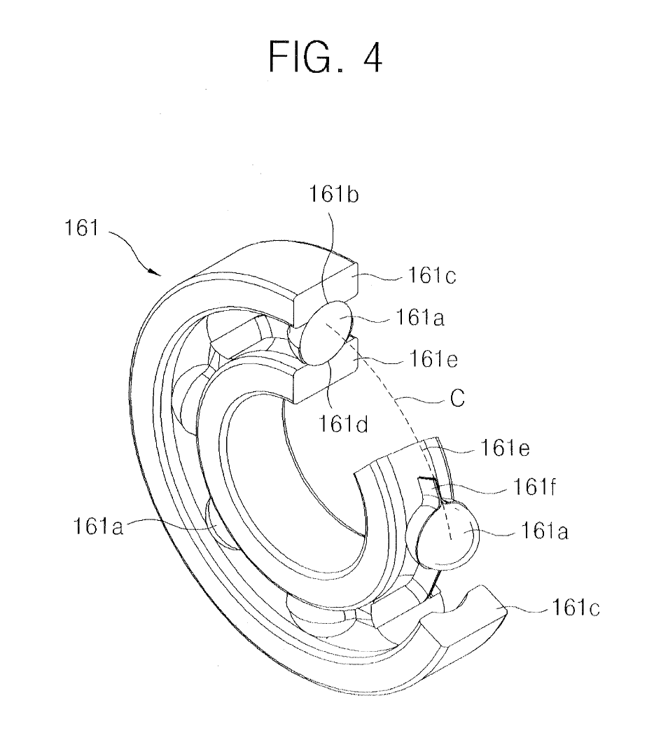

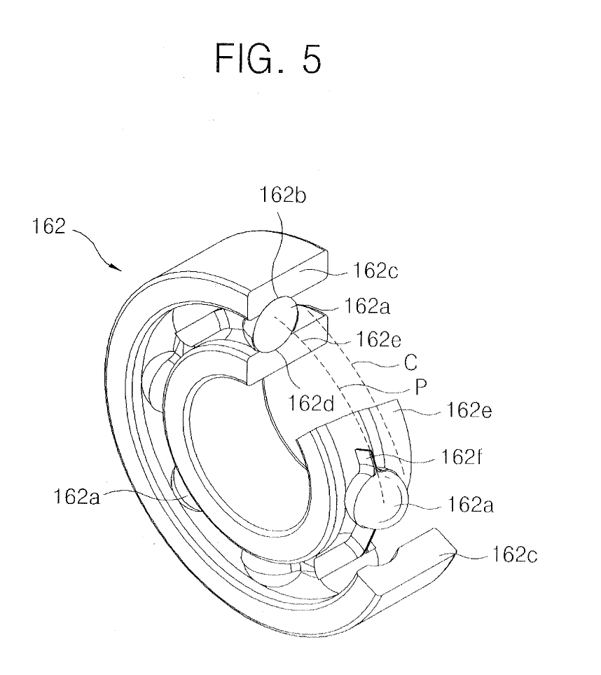

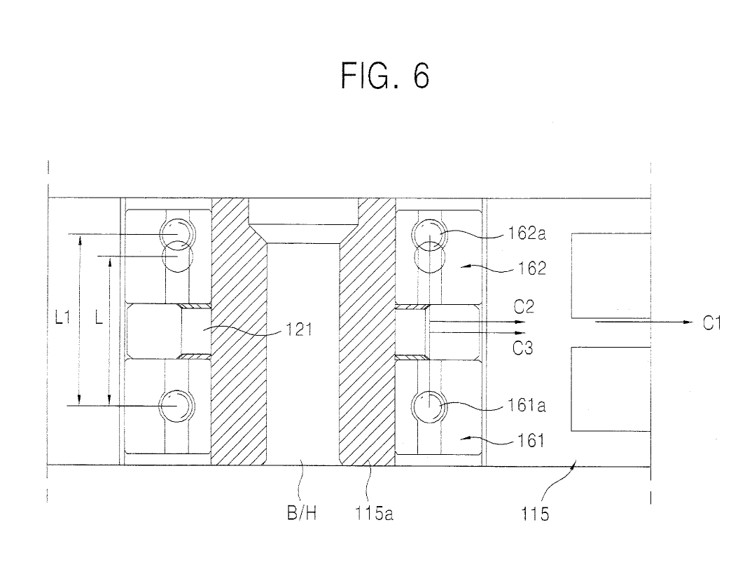

FIG. 1 is an exploded perspective view illustrating a hard disk drive according to an exemplary embodiment of the present general inventive concept, FIG. 2 is a partial perspective view illustrating the head stack assembly (HSA) and voice coil motor (VCM) of the hard disk drive of FIG. 1, FIG. 3 is a partial exploded perspective view illustrating the HSA and pivot shaft of FIG. 1, FIG. 4 is a partial cut-open perspective view illustrating a symmetric pivot bearing, FIG. 5 is a partial cut-open perspective view illustrating an asymmetric pivot bearing, and FIG. 6 is a partial cross-section view illustrating the hard disk drive of FIG. 1 provided with the symmetric pivot bearing of FIG. 4 and the asymmetric pivot bearing of FIG. 5.

Referring to FIG. 1, a hard disk drive 100 according to an exemplary embodiment of the present general inventive concept may include a base 110 that may be internally provided with a plurality of interior component parts related to reading and writing information, a cover 130 provided to a top surface of the base 110 and assembled to the base 110 with the interior component parts therebetween, a gasket 135 interposed between the cover 130 and the base 110 to seal the inner area between the cover 130 and the base 110, and a printed circuit board assembly (PCBA) 140 coupled to the base 110.

Although the “top surface” of the base 110 may be referred to at different times in this description, it is understood that such a directional term is merely relative to the orientation of the hard disk drive 100 illustrated in FIG. 1 and is employed simply to provide an easy frame of reference to understand relative positions of the base 110 and cover 130. It is also understood that if the hard disk drive 100 were to be inverted, the previously described “top surface” of the base 110 could be understood as the “bottom surface”, and so on, but may still receive the provided cover 130 as described in this embodiment of the present general inventive concept.

The base 110 may be provided with the plurality of interior component parts related to reading and writing information. For example, the base 110 may be provided with at least one disk 111 to record and/or store data, a spindle motor 112 provided in the center of the disk 111 to rotate the disk 111, a head stack assembly (HSA) 113 to move a magnetic head 114 to various areas adjacent to the disk 111, etc.

The base 110 may be classified as a flat type in which the interior component parts are provided and/or assembled to a flat top surface thereof, a bowl type in which the interior component parts are accommodated and assembled therein, or various other configurations.

In this embodiment, the bowl-type base 110 will be described, but it is understood that the present general inventive concept is not limited thereto. For example, the present inventive concept may alternatively be applied to the flat-type base (not shown), or to other various configurations of bases.

The hard disk drive 100 in this embodiment of the present general inventive concept may be a small form factor hard disk drive (SFF HDD) in which the disk 111 having a diameter of 1.8 inch is applied, but the present general inventive concept is not limited thereto. For example, the present inventive concept may alternatively be applied to all hard disk drives regardless of large, small and medium forms.

Prior to describing the various interior component parts in the base 110, the cover 130 will be first described. The cover 130 may cover the top surface of the base 110 to protect the plurality of interior component parts.

The cover 130 may be made of metal. For example, the cover 120 may be made by die-casting aluminum alloy, pressing steel, or other similar processes/materials, or a combination of more than one of these.

The cover 130 may be assembled to the base 110 by a plurality of screws 101, e.g., by six screws 101 in this embodiment. Also, the cover 130 may be formed with one or more recesses 131 where a respective head 101a of the screw 101 may be placed.

While the presently described embodiment of the present general inventive concept is described as using the screws 101 to assemble the cover 130 to the base 110, it is understood that any number of alternate fixing and/or adhesion devices may be used instead of, or in conjunction with, the screws 101.

The gasket 135 may be provided to form a seal between the cover 130 and the base 110 when the cover 130 and the base 110 are assembled by the screws 101. The gasket 135 may be made of rubber, and may form a continuous closed loop along a circumference on the top surface of the base 110 as long as it does not interfere with the interior component parts.

Thus, the gasket 135 and the cover 130 may be sequentially provided to the top surface of the base 110, and then the screws 101 may be inserted in holes 130a of the cover 130 and holes 135a of the gasket 135 and fastened to the screw grooves 110a of the base 110, thereby being assembled into the hard disk drive 100.

The PCBA may be coupled to a bottom surface of the base 110. The PCBA 140 may include a printed circuit board (PCB) 141 provided with a plurality of circuit elements, and a connector 142 connected to one side of the PCB 141.

The PCB 141 may be provided with a controller 143 to control various functions of the hard disk drive 100. Further, a plurality of memories 144 may be provided to the PCB 141 so as to store various data, tables and/or the like.

As described above, the HSA 113 may be rotated to move a magnetic head 114 to various areas adjacent to the disk 111 to record data and/or load the data on the disk 111. At this time, the data may be transmitted to the PCBA 140 coupled to the bottom of the base 110 via a flexible printed circuit (FPC) 118.

As one of the interior component parts provided in the base 110, the HSA 113 may include the magnetic head 114 to record and/or load data on the disk 111, and an actuator 115 to fly the magnetic head 114 so that the magnetic head 114 can access a corresponding area on the disk 111 so as to record and/or load the data.

The actuator 115 may be partially shaped like the English letter ‘E’ as illustrated in FIG. 6, and in such a configuration is called an E-block.

The magnetic head 114 may be provided at a front end of a head gimbal 116 extended from and connected to the actuator 115, and may fly while keeping a minute gap between the magnetic head 114 and the surface of the disk 111 by rising up due to an air current on the surface of the disk 111 generated as the plurality of disks 111 rotates at high speed.

As illustrated in FIGS. 2 and 3, the actuator 115 may be coupled (e.g., assembled) to a pivot shaft 115a provided in the base 110, and may rotate with respect to the pivot shaft 115a to move the magnetic head 114 relative to the disk 111. That is, the actuator 115 may move left and right in a rotational manner relative to the pivot shaft 115a according to operations of a voice coil motor (VCM) 117 provided at one end thereof, so that the magnetic head 114 provided at the other end can record or read data on or from a track on the disk 111 while moving in a substantially radial direction relative to the disk 111.

The VCM 117 will be described with reference to FIG. 2. The VCM 117 may be provided at one end part of the HSA 113 that is rotatable with respect to the pivot shaft 115a, and may include a bobbin 117b on which a voice coil 117a is wound, a pair of magnets 117c provided at upper and lower regions of the bobbin 117b with the bobbin 117b therebetween and different in magnetic polarity to generate a magnetic field to interact with an electric field due to the voice coil 117a, and an upper motor casing 117d and lower motor casing 117e to which the pair of magnets 117c are respectively coupled.

The upper motor casing 117d and lower motor casing 117e are so designated according to the positions at which they are provided relative to the base 110. The bobbin 117b may be arranged between the upper and lower motor casings 117d and 117e, and the upper and lower motor casings 117d and 117e may be coupled to the base 110 by one or more bolts B.

In a lower region of the lower motor casing 117e there may be provided a latch 119 to elastically support the actuator 115 and prevent the actuator 115 from voluntarily moving when the magnetic head 114 is parked at a parking zone (not shown) of the disk 111. If a support such as a separate ramp is provided as opposed to the drawings, the magnetic head 114 may be parked in the ramp. In such a configuration, a parking zone may be excluded from the disk 111.

As illustrated in FIGS. 3 to 6, the actuator 115 may be coupled (e.g., assembled) to the pivot shaft 115a of the base 110, so that the magnetic head 114 can record or read data on or from the track on the disk 111 while moving over the disk 111 in a substantiallyradial direction.

For reference, the pivot shaft 115a may be provided integrally with the base 110, or may be provided separately from the base 110 and coupled to the base 110. In a middle region of the pivot shaft 115a there may be formed a bolt hole B/H to which a bolt (not shown) may be fastened to thereby couple the actuator 115 to the base 110. It is understood that this described bolt and bolt hole B/H configuration is merely one example in which the actuator 115 may be coupled to the base 110.

The actuator 115 may be formed with a shaft coupling hole 115b provided at one end of the actuator 115 so as to receive the pivot shaft 115a. The pivot shaft 115a may be received in the shaft coupling hole 115b so as to couple the actuator 115 to the pivot shaft 115a.

In the case in which the actuator 115 is coupled to the pivot shaft 115a by receiving the pivot shaft 115a in the shaft coupling hole 115b of the actuator 115, a pair of first and second pivot bearings 161 and 162 may be first coupled to the pivot shaft 115a, and the actuator 115 may then be coupled to the outside of the first and second pivot bearings 161 and 162 to make the rotation of the actuator 115 smooth. Further, a bearing spacer 121 may be interposed between the first and second pivot bearings 161 and 162.

Thus, while the actuator 115 may be coupled to the pivot shaft 115a, a pivot bearing span, i.e., a distance L (illustrated in FIG. 6) between the respective rotation centers of the first and second pivot bearings 161 and 162 may be adjusted, and a pivot bearing z-location may be adjusted to align a central axis line C2 (illustrated in FIG. 6) between the pivot bearings 161 and 162 with the center C1 (refer to FIG. 6) of gravity the actuator has. The pivot bearing z-location refers to the respective locations of the rotation centers of the first and second pivot bearings 161 and 162 along the length of the pivot shaft 115a.

As described above, both the adjustment of the pivot bearing span and the adjustment of the pivot bearing z-location are generally performed, but at least the pivot bearing span typically has to be adjusted to prevent the actuator 115 from vibrating forward and backward or leftward and rightward with respect to the pivot shaft 115a when the hard disk drive 100 is driven, thereby securing operational reliability of the hard disk drive 100.

TABLE 1

| Pivot bearing span | 0 | 0.2 |
|---|---|---|
| Levering mode [Hz] | 1508 | 1522 |
| Rocking mode [Hz] | 4491 | 4571 |

For example, if the pivot bearing span, i.e., a distance L (illustrated in FIG. 6) between the respective rotation centers of the first and second pivot bearings 161 and 162 is increased from a reference value of ‘0’ to ‘0.2,’ it has been evidenced through a model analysis that a levering mode [Hz] and a rocking mode [Hz] are increased, respectively.

The levering mode [Hz] refers to an action in which the actuator 115 vibrates forward and backward with respect to the pivot shaft 115a (e.g., away from and toward the pivot shaft 115a), and the rocking mode [Hz] refers to an action in which the actuator 115 vibrates left and right with respect to the pivot shaft 115a. If the pivot bearing span increases, the frequencies of the levering mode and the rocking mode increase and thus the vibration relatively decreases. For reference, the frequency and the vibration are in inverse proportion to each other, so that the increase of the frequency is regarded as the decrease of the vibration.

Thus, if the pivot bearing span, i.e., the distance L (illustrated in FIG. 6) between the respective rotation centers of the first and second pivot bearings 161 and 162 is increased, it is advantageous due to the reduction of the vibration of the actuator 115. However, it is impossible to indefinitely increase the pivot bearing span, so that the pivot bearing span is adjusted within a proper range based on tolerance of component parts such as the actuator or assembling allowance. Accordingly, the pivot bearing span may be adjusted to increase or decrease as necessary.

The adjustment of the pivot bearing span has been conventionally performed by changing the structure of the bearing spacer 121 or other neighboring parts. However, in this embodiment of the present general inventive concept, the pivot bearing span can be adjusted by a simple and uncomplicated method without changing the structure of the bearing spacer 121 or other neighboring parts.

According to this embodiment of the present general inventive concept, the adjustment of the pivot bearing span may be performed by different configurations of the first and/or second pivot bearings 161 and 162 provided in the form of a ball bearing.

In this embodiment, the first pivot bearing 161 may be provided with a symmetric pivot bearing, and the second pivot bearing 162 may be provided with an asymmetric pivot bearing. However, as will be described later, a pair of asymmetric pivot bearings may be provided in other embodiments of the present general inventive concept.

Referring to FIG. 4, the configuration of the first pivot bearing 161 provided with the symmetric pivot bearing may be as follows. The first pivot bearing 161 may include a plurality of rotation balls 161a provided internally to form the rotation center, an external wheel 161c internally provided with a hemispherical external wheel groove 161b in which one side of the respective rotation balls 161a may be partially accommodated and may be coupled to the actuator 115 at an external surface of the external wheel 161c, and an internal wheel 161e externally provided with a hemispherical internal wheel groove 161d in which the other side of the respective rotation balls 161a may be partially accommodated and may be coupled to the pivot shaft 115a at an internal surface of the internal wheel 161e. The rotation balls 161a may be supported by a retainer 161f. As the symmetric pivot bearing, the first pivot bearing 161 may be provided with the rotation balls 161a positioned at the central axis line C in a direction of the thickness of the first pivot bearing 161.

Referring to FIG. 5, the configuration of the second pivot bearing 162 provided with the asymmetric pivot bearing may be as follows. The second pivot bearing 162 may include a plurality of rotation balls 162a provided internally to form the rotation center, an external wheel 162c internally provided with a hemispherical external wheel groove 162b in which one side of the respective rotation balls 161a may be partially accommodated and may be coupled to the actuator 115 at an external surface of the external wheel 162c, and an internal wheel 162e externally provided with a hemispherical internal wheel groove 162d in which the other side of the respective rotation balls 162a may be partially accommodated and may be coupled to the pivot shaft 115a at an internal surface of the internal wheel 162e. The rotation balls 162a may be supported by the retainer 161f.

As the asymmetric pivot bearing, the second pivot bearing 162 may be provided such that the respective rotation centers of the rotation balls 162a are placed at a position P distant from the central axis line C in the direction of the thickness of the second pivot bearing 162. Thus, there are various kinds of the asymmetric pivot bearings according to positions of the internal rotation balls 162a. In other words, various configurations of such an asymmetric pivot bearing may be produced by adjusting the position P by varying the distance from the central axis line C of the asymmetric pivot bearing.

With such a configuration of at least one of the first and second pivot bearings 161 and 162, the hard disk drive 100 according to this embodiment of the present general inventive concept will be described with reference to FIG. 6.

As described above, when the actuator 115 in this embodiment is coupled to the base 110 through the pivot shaft 115a and the first and second pivot bearings 161 and 162, the bearing spacer 121 may be coupled to the first pivot bearing 161 provided with the symmetric bearing, and then the second pivot bearing 162 provided with the asymmetric bearing may be coupled to the bearing spacer 121.

In such a configuration, with the asymmetric bearing being provided in the second pivot bearing 162, a pivot bearing span L1 is increased as compared to the previously described reference pivot bearing span L based on two symmetric pivot bearings. Thus, the actuator 115 may be prevented from vibrating forward and backward or leftward and rightward with respect to the pivot shaft 115a.

Further, if the asymmetric pivot bearing is used as the second pivot bearing 162, the pivot bearing z-location can be conveniently adjusted to align a central axis line C2 between the pivot bearings 161 and 162 with the center C1 of gravity the actuator 115 has.

For example, if one pair of symmetric pivot bearings is used, as in a conventional structure, the structure of the bearing spacer 121 or other neighboring parts has to be changed to align a central axis line C3 between the symmetric pivot bearings with the center C1 of gravity the actuator 115 has. On the other hand, in this embodiment, such alignment can be achieved by using the asymmetric pivot bearing as the second pivot bearing 162. In other words, if the asymmetric pivot bearing is employed as the second pivot bearing 162, the central axis line C2 between the respective rotation centers of the first and second pivot bearings 161 and 162 can be easily aligned with the center C1 of gravity of the actuator 115.

Thus, according to an exemplary embodiment of the present general inventive concept, the pivot bearing span and the pivot bearing z-location can be adjusted by a simple and uncomplicated method without changing a structure of the bearing spacer 121 or other neighboring parts.

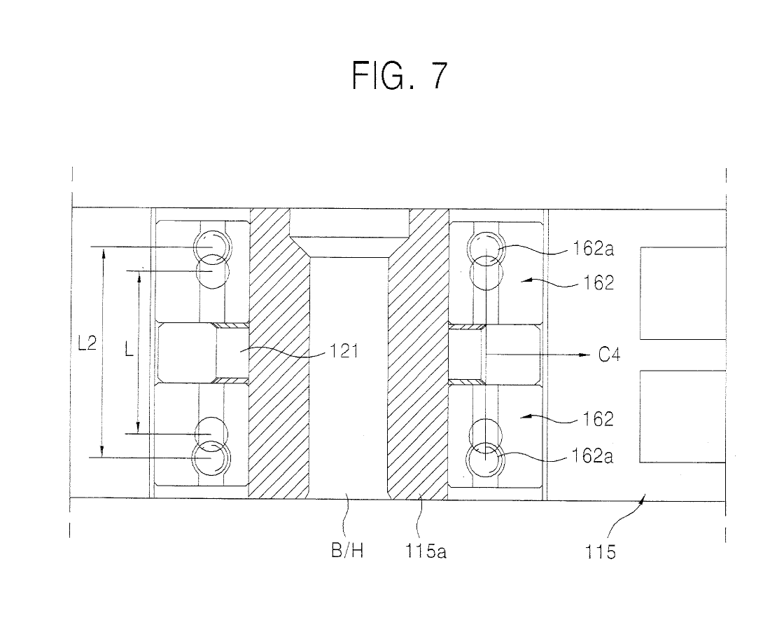

FIGS. 7 to 11 are partial cross-section views illustrating hard disk drives according to other exemplary embodiments of the present general inventive concept.

As illustrated in FIGS. 7-10, the asymmetric bearings illustrated in FIG. 5 are provided in pairs separated by the bearing spacer 121 in these embodiments of the present general inventive concept, rather than one asymmetric second pivot bearing 162 being paired with one symmetric first pivot bearing 161 as illustrated in FIG. 6. Although the asymmetric bearing 162 illustrated in FIG. 5 may be provided above and/or below the bearing spacer 121, and further may be inverted to increase or decrease a distance of a conventional reference pivot bearing span L, the same reference numeral is used to indicate both of the pair of asymmetric pivot bearings for convenience.

Referring to FIG. 7, one pair of asymmetric pivot bearings 162 may be provided so that the rotation balls 162a thereof can be arranged in opposite directions with respect to the bearing spacer 121 and distant from each other. More particularly, both asymmetric pivot bearings 162 in this embodiment are provided such that the rotation balls 162a are farther away from the bearing spacer 121 than the central axis line C of the asymmetric pivot bearing 162 illustrated in FIG. 5. Here, L2 indicates the pivot bearing span, and C4 indicates the central axis line between the respective rotation centers of the pair of asymmetric pivot bearings 162.

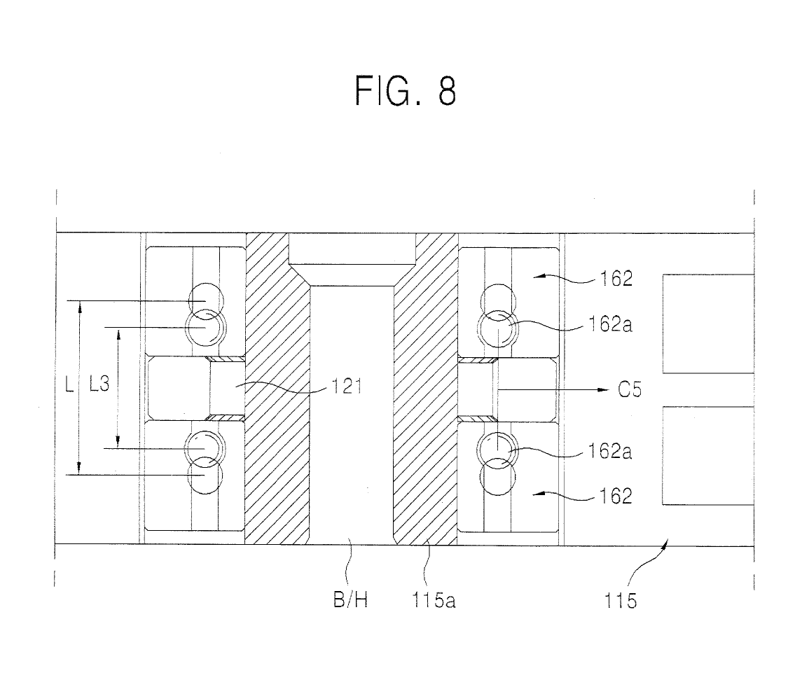

Referring to FIG. 8, one pair of asymmetric pivot bearings 162 may be provided so that the rotation balls 162a thereof can be arranged in opposite directions with respect to the bearing spacer 121 and close to each other. More particularly, both asymmetric pivot bearings 162 in this embodiment are provided such that the rotation balls 162a are closer to the bearing spacer 121 than the central axis line C of the asymmetric pivot bearing 162 illustrated in FIG. 5. Here, L3 indicates the pivot bearing span, and C5 indicates the central axis line between the respective rotation centers of the pair of asymmetric pivot bearings 162.

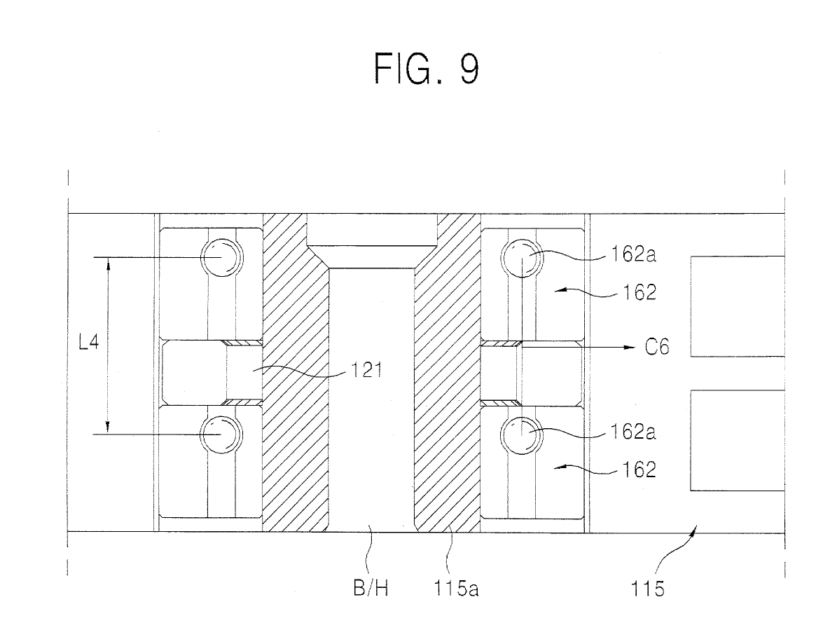

Referring to FIG. 9, one pair of asymmetric pivot bearings 162 may be provided so that the rotation balls 162a thereof can be biased in the same direction, i.e., upward along a lengthwise direction of the pivot shaft 115a. More particularly, the upper asymmetric pivot bearing 162 in this embodiment is provided such that the rotation balls 162a are farther away from the bearing spacer 121 than the central axis line C of the asymmetric pivot bearing 162 illustrated in FIG. 5, and the lower asymmetric pivot bearing 162 is provided such that the rotation balls 162a are closer to the bearing spacer 121 than the central axis line C. Here, L4 indicates the pivot bearing span, and C6 indicates the central axis line between the respective rotation centers of the pair of asymmetric pivot bearings 162.

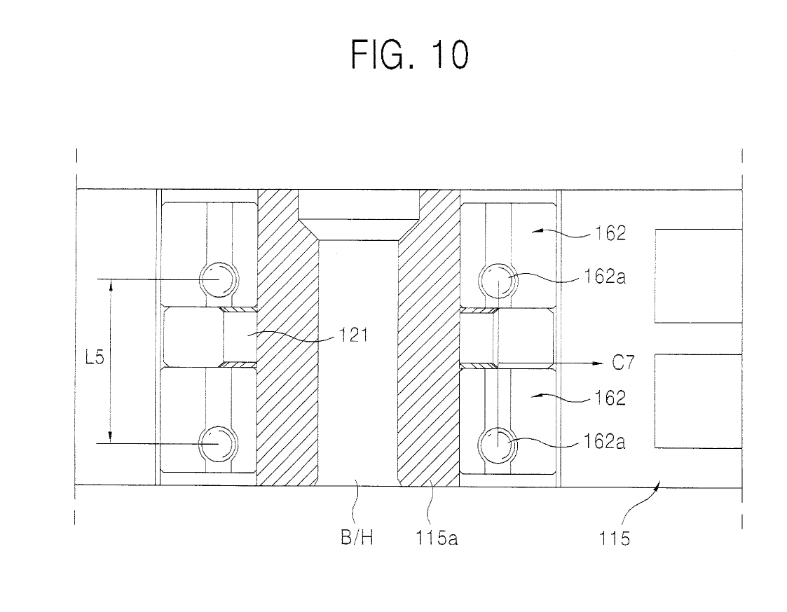

Referring to FIG. 10, one pair of asymmetric pivot bearings 162 may be provided so that the rotation balls 162a thereof can be biased in the same direction, i.e., downward along a lengthwise direction of the pivot shaft 115a. More particularly, the upper asymmetric pivot bearing 162 in this embodiment is provided such that the rotation balls 162a are closer to the bearing spacer 121 than the central axis line C of the asymmetric pivot bearing 162 illustrated in FIG. 5, and the lower asymmetric pivot bearing 162 is provided such that the rotation balls 162a are farther away from the bearing spacer 121 than the central axis line C. Here, L5 indicates the pivot bearing span, and C7 indicates the central axis line between the respective rotation centers of the pair of asymmetric pivot bearings 162.

Although the embodiments illustrated in FIGS. 7-10 include different configurations employing pairs of the same asymmetric pivot bearings 162, it is understood that the pivot bearings having rotation balls at different asymmetric locations may be provided to further adjust the pivot span. In other words, the position P of the respective rotation centers of one of the pair of asymmetric pivot bearings may be different than the position P of the respective rotation centers of the other of the pair of asymmetric pivot bearings.

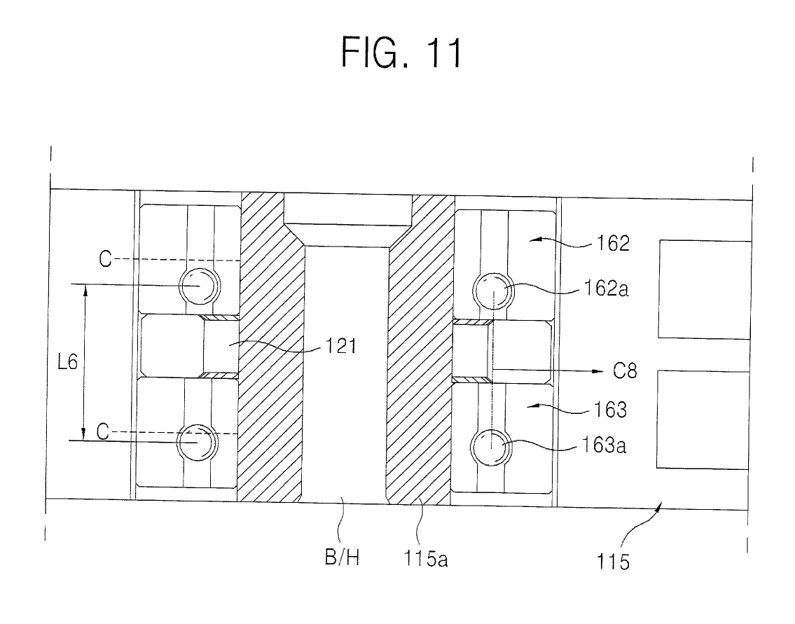

For example, FIG. 11 illustrates a pair of asymmetric bearings including the previously described asymmetric pivot bearing 162 and a differently configured asymmetric pivot bearing 163. More particularly, the rotation balls 163a are provided at a different distance from the central axis line C of the asymmetric pivot bearing 163 compared to the rotation balls 162a of the asymmetric pivot bearing 162. Compared to the configuration illustrated in FIG. 10, in FIG. 11 the upper asymmetric pivot bearing 162 is provided such that the rotation balls 162a are closer to the bearing spacer 121 than the central axis line C, and the lower asymmetric pivot bearing 163 is provided such that the rotation balls 163a are farther away from the bearing spacer 121 than the central axis line C, yet at a smaller distance from the central axis line C than the distance from the rotation balls 162a from the central axis line C of the upper asymmetric pivot bearing 162. Here, L6 indicates the pivot bearing span, and C8 indicates the central axis line between the respective rotation centers of the pair of asymmetric pivot bearings 162.

In the embodiments illustrated in FIGS. 7 to 11, the pivot bearing span and the pivot bearing z-location can be adjusted by a simple and uncomplicated method without changing a structure of the bearing spacer 121 or other neighboring parts.

Although not all of the possible configuration according to the present general inventive concept have been described in the foregoing embodiments, it is understood that the pivot bearing span and the pivot bearing z-location can be adjusted by a combination of one symmetric pivot bearing and one among various kinds of the asymmetric pivot bearings or by a combination of two among various kinds of the asymmetric pivot bearings, as there is basically one type of the symmetric pivot bearing having the rotation ball at the center thereof, but there are various types of the asymmetric pivot bearings according to positions of the rotation balls.

As described above, there is provided a hard disk drive which can adjust a pivot bearing span and a pivot bearing z-location by a simple and uncomplicated method without changing a structure of a bearing spacer or other neighboring parts.

Although various exemplary embodiments of the present general inventive concept have been illustrated and described, it will be appreciated by those skilled in the art that changes may be made in these example embodiments without departing from the principles and spirit of the general inventive concept, the scope of which is defined in the appended claims and their equivalents.

What is claimed is:

1. A hard disk drive comprising:
an actuator provided with a magnetic head;
a pivot shaft to which the actuator is coupled and which forms a rotation axis of the actuator; and
first and second pivot bearings each internally including rotation balls forming a rotation center and coupled to the pivot shaft to assist rotation of the actuator;
wherein at least one of the first and second pivot bearings is configured as an asymmetric pivot bearing having the rotation balls provided at a preset distance from a central axis line in a thickness direction of the asymmetric pivot bearing.

2. The hard disk drive according to claim 1, wherein both of the first and second pivot bearings have the asymmetric pivot bearing configuration.

3. The hard disk drive according to claim 2, wherein the rotation bolls provided in the first and second pivot bearings are arranged more distantly from each other than a distance between the central axis lines in the thickness direction of the first and second pivot bearings.

4. The hard disk drive according to claim 2, wherein the rotation bolls provided in the first and second pivot bearings are arranged closer to each other than a distance between the central axis lines in the thickness direction of the first and second pivot bearings.

5. The hard disk drive according to claim 2, wherein the rotation bolls provided in the first and second pivot bearings are distant in the same direction with respect to the central axis lines in the thickness direction of the first and second pivot bearings.

6. The hard disk drive according to claim 1, wherein the first pivot bearing has the asymmetric pivot bearing configuration; and
the second pivot bearing has a symmetric pivot bearing configuration having the rotation balls provided substantially symmetrically with respect to a thickness direction.

7. The hard disk drive according to claim 6, wherein each of the first and second pivot bearings comprises:
an external wheel internally formed with a hemispherical external wheel groove to partially accommodate the respective rotation balls and externally coupled to the actuator; and
an internal wheel externally formed with a hemispherical internal wheel groove to partially accommodate the respective rotation balls and internally coupled to the pivot shaft.

8. The hard disk drive according to claim 7, wherein both the first and second pivot bearings comprise a ball bearing.

9. The hard disk drive according to claim 1, further comprising a bearing spacer provided between the first and second pivot bearings.

10. The hard disk drive according to claim 1, wherein a pivot bearing span between the respective rotation centers of the first and second pivot bearings and a pivot bearing z-location to align a central axis line between the first and second pivot bearings with the center of gravity of the actuator is adjusted by selective combination of the first and second pivot bearings.

11. A hard disk drive having an actuator coupled to a pivot part about which the actuator rotates, comprising:
first and second pivot bearings coupled to the actuator and the pivot part;
wherein a rotation center of the first pivot bearing is offset from a longitudinal center of the first pivot bearing.

12. The hard disk drive of claim 11, further comprising a bearing spacer provided between the first and second pivot bearings.

13. The hard disk drive of claim 11, wherein the rotation center of the first pivot bearing is closer to the second pivot bearing than is the longitudinal center of the first pivot bearing.

14. The hard disk drive of claim 11, wherein the rotation center of the first pivot bearing is farther from the second pivot bearing than is the longitudinal center of the first pivot bearing.

15. The hard disk drive of claim 11, wherein the first and second pivot bearings are each provided with a plurality of rotation balls to form respective rotation centers of the first and second pivot bearings.

16. The hard disk drive of claim 11, wherein a rotation center of the second pivot bearing is offset from a longitudinal center of the second pivot bearing.

17. The hard disk drive of claim 16, wherein a distance between the rotation centers of the first and second pivot bearings is shorter than a distance between the longitudinal centers of the first and second pivot bearings.

18. The hard disk drive of claim 16, wherein a distance between the rotation centers of the first and second pivot bearings is longer than a distance between the longitudinal centers of the first and second pivot bearings.

19. The hard disk drive of claim 16 wherein a distance between the rotation centers of the first and second pivot bearings is substantially equal to a distance between the longitudinal centers of the first and second pivot bearings.

20. The hard disk drive of claim 16, wherein the respective rotation centers of the first and second pivot bearings are offset at equal distances from the respective longitudinal centers of the first and second pivot bearings.

21. The hard disk drive of claim 16, wherein a distance between the rotation center of the first pivot bearing and the longitudinal center of the first pivot bearing is shorter than a distance between the rotation center of the second pivot bearing and the longitudinal center of the second pivot bearing.
